(19) United States
(12) Patent Application Publication
(10) Pub. No.: US 2024/0429639 A1
(43) Pub. Date: Dec. 26, 2024

(54) CONNECTOR CAP

(71) Applicant: SHOALS TECHNOLOGIES GROUP, LLC, Portland, TN (US)

(72) Inventor: Dorothy Michael, Greenbrier, TN (US)

(73) Assignee: SHOALS TECHNOLOGIES GROUP, LLC, Portland, TN (US)

(21) Appl. No.: 18/749,385

(22) Filed: Jun. 20, 2024

Related U.S. Application Data
(60) Provisional application No. 63/509,734, filed on Jun. 22, 2023.

(51) Int. Cl. H01R 13/447

(52) U.S. Cl. CPC H01R 13/447

(57) ABSTRACT

A connector cap may include a socket, plug, and wall. The socket may partially define a recess. The socket may be configured to interlock with a plug end of a first device to position part of the plug end of the first device within the recess. The plug may be configured to mate with a socket end of a second device to interlock the plug and the socket end of the second device and to position part of the plug within an inner volume of the socket end of the second device. The wall may be connected to the socket and the plug. The wall may further define the recess. The wall, the socket, and the plug may electrically isolate the plug end of the first device from the socket end of the second device when the first device and the second device are interlocked with the connector cap.

### CROSS-REFERENCE TO RELATED APPLICATION

This patent application claims the benefit of and priority to U.S. Provisional App. No. 63/509,734 filed Jun. 22, 2023, titled “CONNECTOR CAP,” which is incorporated in the present disclosure by reference in its entirety.

### FIELD

The embodiments discussed in the present disclosure are related to a connector cap.

### BACKGROUND

Unless otherwise indicated in the present disclosure, the materials described in the present disclosure are not prior art to the claims in the present application and are not admitted to be prior art by inclusion in this section.

A power installation may include cables that are electrically coupled to components via a socket end or a plug end of the cables or the components. To protect conductors of the cables and the components when the plug ends and the socket ends are not connected, multiple individual caps may be connected to the plug ends and the socket ends.

The individual caps may be connected to the plug ends and the socket ends via only friction between the caps and the plug ends or the socket ends. External forces may be applied to the caps, the plug ends, the socket ends, or some combination thereof that are greater than the friction between the corresponding caps and the plug ends or the socket ends. The external forces exceeding the friction may cause the caps to detach (e.g., fall off) from the plug ends or the socket ends. Detachment of the caps may expose corresponding inner volumes of the plug ends or the socket ends to environmental elements such as dirt and other contaminants. This exposure may damage conductors or shorten a life span of the cables or the components and increase a cost to operate the power installation. Furthermore, the friction fit of the caps and the socket ends or the plug ends may prohibit the caps from being used as lockout devices to disable at least part of the power installation. Furthermore, the individual caps may be compatible with only one end type (e.g., either the socket ends or the plug ends), but not both end types. The caps being compatible with only a single end type may increase the types of caps that are needed to protect the cables or may increase the complexity to install, maintain, or operate the power installation.

Accordingly, there is a need for a cap that reduces the cost to operate the power installation and/or the complexity to install, maintain, or operate the power installation. Further, there is a need for a cap that is not prohibited from being used as a lockout device.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Embodiments of the present disclosure address the problems of caps not being prohibited from being used as lockout devices. In addition, embodiments of the present disclosure reduce the number of types of caps that are needed to protect cables of a power installation. In particular, disclosed embodiments include a connector cap that is configured to interlock with (e.g., connect to) both the socket ends and the plug ends. The connector cap may include a plug portion that is configured to interlock with the socket ends and may include a socket portion that is configured to interlock with the plug ends. In addition, the connector cap is configured to electrically isolate the conductor of the plug ends within a recess defined by the connector cap.

The connector cap may include a socket portion that is interlocked with the plug portion via a wall. The socket portion of the connector cap may interlock with a plug end such that an inner volume of the plug end is protected from environmental elements. In addition, the socket portion may interlock with the plug end such that at least part of a conductor of the plug end is positioned within a first recess defined at least partially by the socket portion to electrically isolate the conductor from other circuit elements.

The plug portion may interlock with a socket end such that an inner volume of the socket end is protected from the environmental elements. In addition, the plug portion may interlock with the socket end such that at least part of the plug portion is positioned within the inner volume of the socket end to electrically isolate a conductor of the socket end from other circuit elements. For example, the plug portion may interlock with the socket end such that the conductor of the socket end is electrically isolated from the conductor of the plug end or vice versa.

Therefore, the connector cap may interlock with both a socket end and a plug end to protect the socket end and the plug end from the environmental elements, which eliminates the need for multiple cap types and may reduce a cost to operate the power installation and/or the complexity to install, maintain, and/or operate the power installation. In addition, the connector cap may electrically isolate the conductor of the plug end and the socket end from each other or from other circuit elements to permit the connector cap to be used as a lockout device.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1A illustrates an operational diagram of an example solar installation that includes solar panels arranged in series and includes a connector cap to disable portions of the solar installation and/or to prevent contamination of cables of the solar installation;

FIG. 1B illustrates an operational diagram of another example solar installation that includes solar panels arranged in parallel and includes multiple connector caps to disable portions of the solar installation and/or to prevent contamination of cables of the solar installation;

FIGS. 2A-2I illustrate a perspective view, a top view, a bottom view, a left view, a right view, a front view, a back view, a perspective cross-sectional view, and a top cross-sectional view of an example of the connector cap(s) of FIGS. 1A and 1B;

FIG. 3 illustrates a separated view of an example junction that includes the example connector cap of FIGS. 2A-2I including an O-ring, an example socket end, and an example plug end; and

FIG. 4 illustrates a top cross-sectional view of an example junction that includes the example connector cap of FIGS. 2A-2I interlocked with the example plug end and the example socket end;

all according to at least one embodiment described in the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

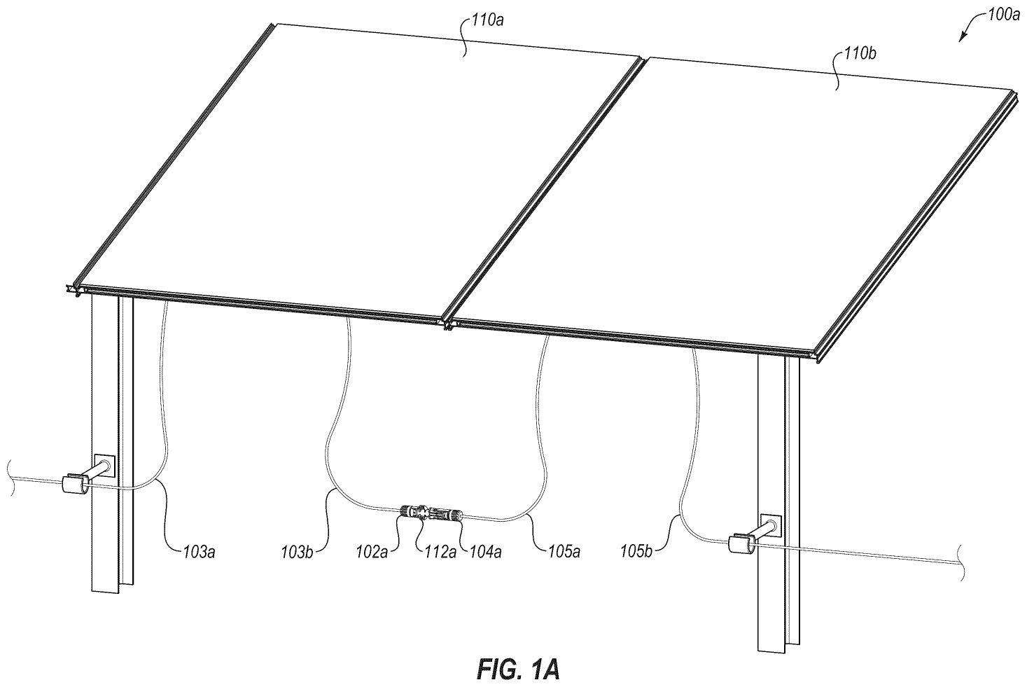

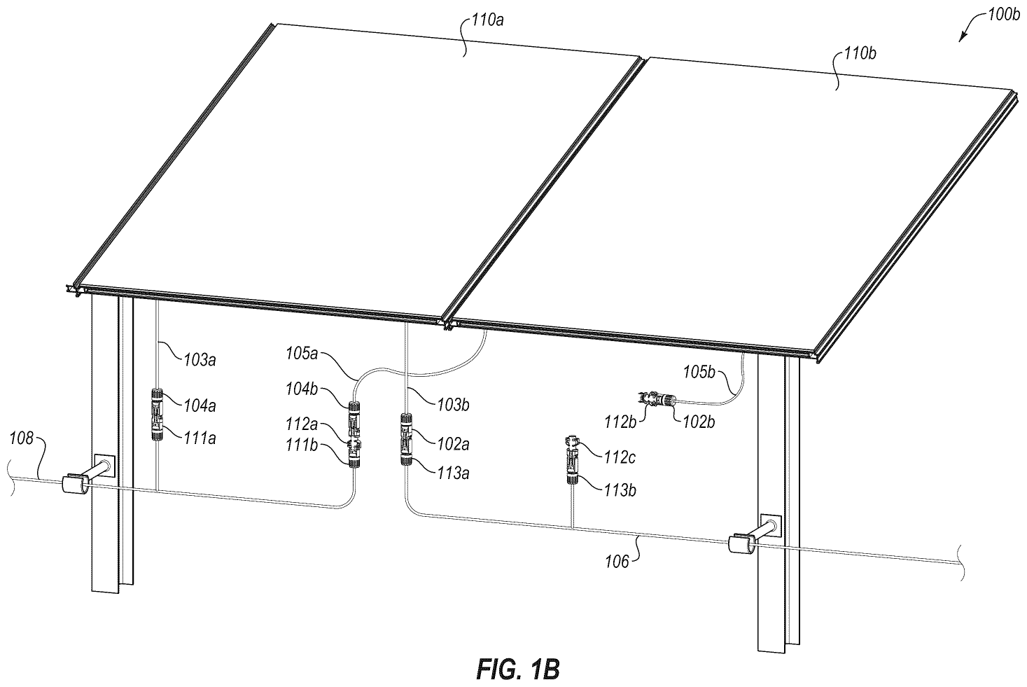

With reference to FIG. 1A, an example of one type of system environment in which aspects of the present disclosure might be used is shown. Shown in FIG. 1A is an embodiment of a solar installation 100a that includes solar panels 110a-b arranged in a series configuration. During operation, the solar panels 110a-b may provide power signals to other components (not illustrated in FIG. 1A) of the solar installation 100a via the cables 103a-b and 105a-b. Examples of the other components of the solar installation 100a may include one or more batteries, an inverter, a combiner, a grid, a wiring harness, combiners, or any other appropriate component. Additionally or alternatively, the solar panels 110a-b may provide the power signals to each other.

The solar installation 100a is illustrated in FIG. 1A as being disabled due to a connector cap 112a electrically isolating conductors of a plug end 102a of the cable 103b and a socket end 104a of the cable 105a from each other and any other component or voltage source in the solar installation 100a. The connector cap 112a may disable the solar installation 100a to permit repairs, troubleshooting, upgrades, maintenance, or any other appropriate operation to be performed on the solar installation 100a.

The cable 103a may be electrically coupled to a negative terminal of the solar panel 110a and another component of the solar installation 100a (e.g., a positive terminal of another solar panel (potentially with one or more intervening components) or a positive wiring harness not illustrated in FIG. 1A). In addition, the cable 103b may be electrically coupled to a positive terminal of the solar panel 110a. Further, the cable 105a may be electrically coupled to a negative terminal of the solar panel 110b. The cable 105b may be electrically coupled to a positive terminal of the solar panel 110b and another component of the solar installation 100a (e.g., a negative terminal of another solar panel (potentially with one or more intervening components) or a negative wiring harness not illustrated in FIG. 1A).

The connector cap 112a is illustrated in FIG. 1A as interlocking with the plug end 102a and the socket end 104a to electrically isolate the conductors of the plug end 102a and the socket end 104a from other circuit elements to create an open within the solar installation 100a to disable the solar installation 100a. In some embodiments, the other circuit elements may include any conductive material that could electrically couple to the conductors of the plug end 102a and the socket end 104a. As shown in FIG. 1A, the connector cap 112a electrically isolates the conductors of the plug end 102a and the socket end 104a from each other to create the open. The connector cap 112a is illustrated in FIG. 1A as disabling the entire solar installation 100a due to the solar panels 110a-b being arranged in series. However, the connector cap 112a may be configured to disable only a portion of the solar installation 100a. An example of connector caps disabling only a portion of a solar installation is described in detail below in relation to FIG. 1B.

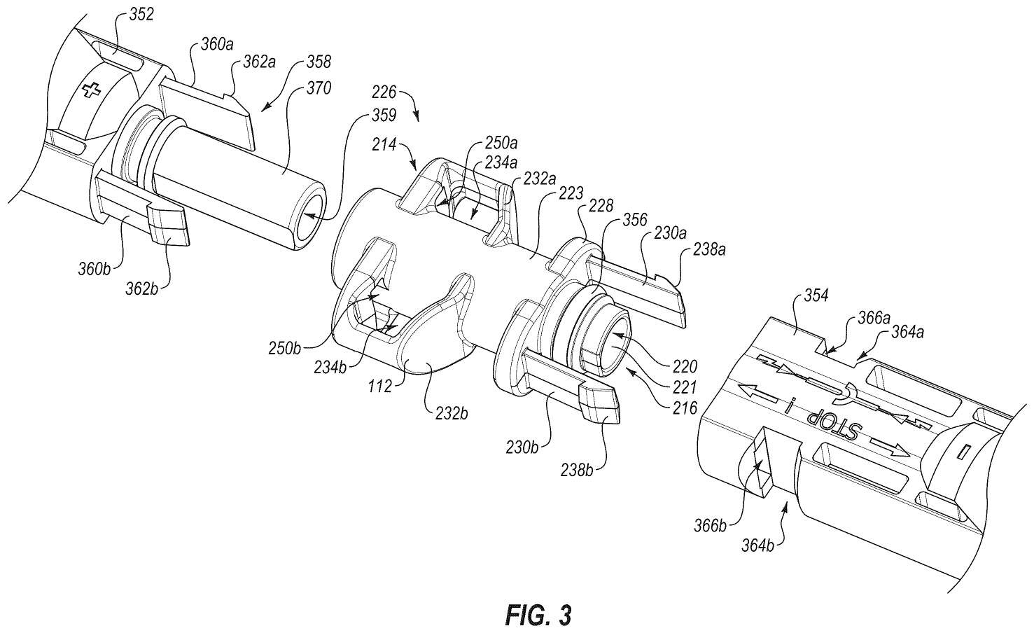

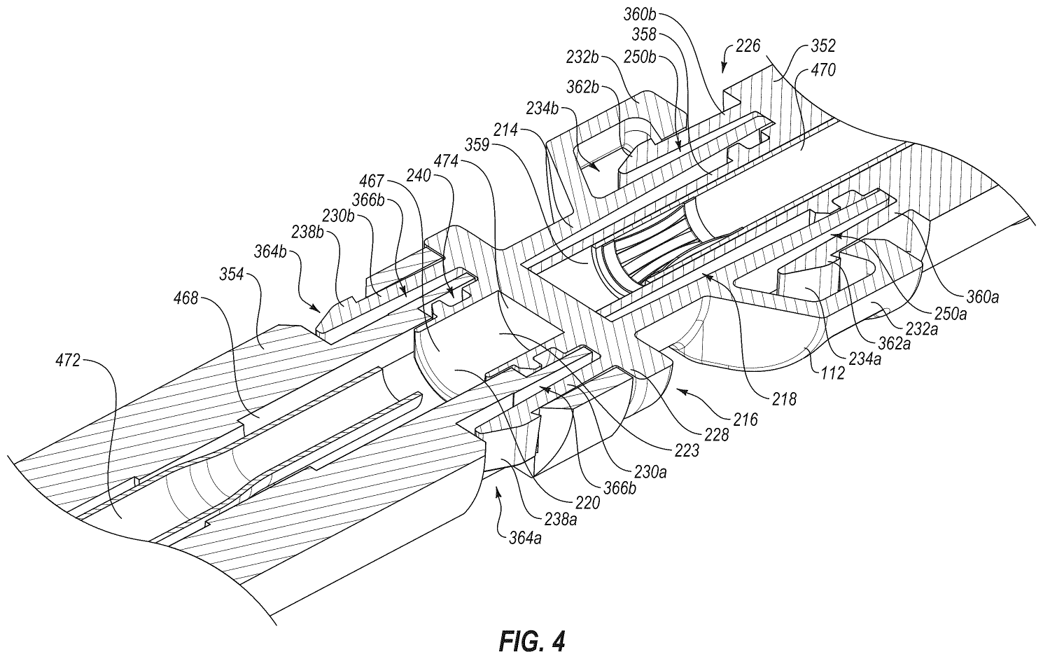

Additionally or alternatively, the connector cap 112a may prevent environmental elements such as dirt and other contaminants from getting into the plug end 102a, the socket end 104a, or both. In some embodiments, one or both of the plug end 102a or the socket end 104a include inner volumes (such as denoted 359 and 468 in FIGS. 3 and 4) and the connector cap 112a may prevent the environmental elements from getting into the inner volumes of the plug end 102a or the socket end 104a. In some embodiments, the connector cap 112a may prevent the environmental elements from getting into the inner volumes of the plug end 102a or the socket end 104a and degrading functionality of the conductors. The connector cap 112a may be configured to prevent the environmental elements from getting into the inner volumes whenever the connector cap 112a is interlocked with the plug end 102a or the socket end 104a. In some embodiments, the connector cap 112a may be interlocked with the plug end 102a or the socket end 104a during transportation of the cables 103b and 105a. Additionally or alternatively, the connector cap 112a may be interlocked with the plug end 102a or the socket end 104a during installation of the cables 103b and 105a, maintenance of the components of the solar installation 100a, troubleshooting of the solar installation 100a, repair of the components of the solar installation 100a, or any other appropriate operation in which the environmental elements could get into the inner volumes of the plug end 102a or the socket end 104a. In some embodiments, one or both of the plug end 102a or the socket end 104a includes a protrusion and the connector cap 112a may encompass some or all of the protrusion to prevent exposure of some or all of the protrusion to the environmental elements.

The connector cap 112a is illustrated in FIG. 1A as being interlocked with both the plug end 102a and the socket end 104a for example purposes. Alternatively, the solar installation 100a may include two connector caps with each connector cap interlocked with a different one of the plug end 102a and the socket end 104a. For example, the connector cap 112a may be interlocked with the plug end 102a and the additional connector cap may be interlocked with the socket end 104a.

With reference to FIG. 1B, an example of another type of system environment in which aspects of the present disclosure might be used is shown. Shown in FIG. 1B is an embodiment of a solar installation 100b that includes the solar panels 110a-b arranged in a parallel configuration. A portion of the solar installation 100b of FIG. 1B is disabled by connector caps 112a-c. In particular, the connector cap 112a is illustrated in FIG. 1B as electrically isolating conductors of the socket end 104a of the cable 105a from other circuit elements (e.g., a negative wiring harness 108) In addition, the connector cap 112b is illustrated in FIG. 1B as electrically isolating a conductor of a plug end 102b of the cable 105b from other circuit elements and the connector cap 112c is illustrated in FIG. 1B as electrically isolating a conductor of a socket end 113b of a positive wiring harness 106 to disable the solar panel 110b. The connector caps 112a-c may disable the solar panel 110b to permit repairs, troubleshooting, upgrades, or other maintenance operations to be performed on the cables 105a-b, the solar panel 110b, or both while permitting the solar panel 110a to continue to operate due to the parallel arrangement of the solar installation 100b. In particular, in the parallel arrangement of FIG. 1B, the connector caps 112a-c permit electrical isolation of the solar panel 110b from other circuit elements within the solar installation 100b without disconnecting (or electrically isolating) the solar panel 110a (or other solar panels) from the other circuit elements within the solar installation 100b.

The connector cap 112b may electrically isolate the conductor of the plug end 102b of the cable 105b to create an open within the solar installation 100b. More specifically, the connector cap 112b may electrically isolate the conductor from all other circuit elements to create the open and to prevent an unintentional electrical connection. Additionally, the connector cap 112c may electrically isolate the conductor of the socket end 113b of the positive wiring harness 106 from all other circuit elements to prevent an unintentional electrical connection. The connector cap 112b is illustrated in FIG. 1B as being disconnected from the positive wiring harness 106 and the connector cap 112c is illustrated in FIG. 1B as being interlocked with the positive wiring harness 106 as an example configuration. The connector cap 112b may be disconnected from the positive wiring harness 106 to, for example, permit the cable 105b to be replaced, the cable 105b to be re-routed, the positive wiring harness 106 to be moved, the positive wiring harness 106 to be replaced, or any other appropriate action to be taken. Alternatively, either of the connector caps 112b-c may be omitted and the other connector cap may interlock with the positive wiring harness as well as the plug end 102b of the cable 105b while electrically isolating one from the other.

The connector cap 112a is illustrated in FIG. 1B as interlocking with the socket end 104a of the cable 105a and the negative wiring harness 108. The connector cap 112a may electrically isolate the socket end 104a of the cable 105a from other circuit elements (e.g., the negative wiring harness 108) to create another open within the solar installation 100b. More specifically, the connector cap 112a may electrically isolate the conductors of the socket end 104a of the cable 105a and the negative wiring harness 108 from each other and other circuit elements to prevent an unintentional electrical connection. Alternatively, the connector cap 112a may be interlocked with the socket end 104a of the cable 105a and disconnected from the negative wiring harness 108.

Additionally or alternatively, the connector caps 112a-c may prevent the environmental elements from getting into the inner volumes of the plug end 102b of the cable 105b, the socket end 104a of the cable 105a, and/or the socket end 113b of the negative wiring harness 108 similar to the connector cap 112a as described above in relation to FIG. 1A. More generally, the connectors caps 112a-c may prevent exposure of conductors of plug ends and/or socket ends of cables to environmental elements, whether the plug ends and/or socket ends define inner volumes, have protrusions, or have any other configuration.

The solar installation 100b is illustrated and described with the connector cap 112b being interlocked with the plug end 102b of the cable 105b and with the connector cap 112a being interlocked with both the socket end 104a of the cable 105a and the negative wiring harness 108 for example purposes. The solar installation 100b may include more connector caps that are interlocked with socket end 104b of the cable 103a, the plug end 102a of the cable 103b, the negative wiring harness 108, the positive wiring harness 106, or some combination thereof to create more opens in the solar installation 100b.

With combined reference to FIGS. 1A and 1B, in some embodiments, the connector caps 112a-c may be compatible with Multi-Contact (MC) 4 connectors. In these and other embodiments, the plug ends 102a-b may correspond to positive feeds within the solar installations 100a-b and the socket ends 104a-b may correspond to negative feeds within the solar installations 100a-b. In other embodiments, the polarities may be reversed (e.g., plug ends 102a-b may correspond to negative feeds and socket ends 104a-b may correspond to positive feeds). The connector caps 112a-b may be configured to interlock with the plug ends 102a-b, the socket ends 104a-b, or both to create opens in the positive feeds and/or the negative feeds within the solar installations 100a-b.

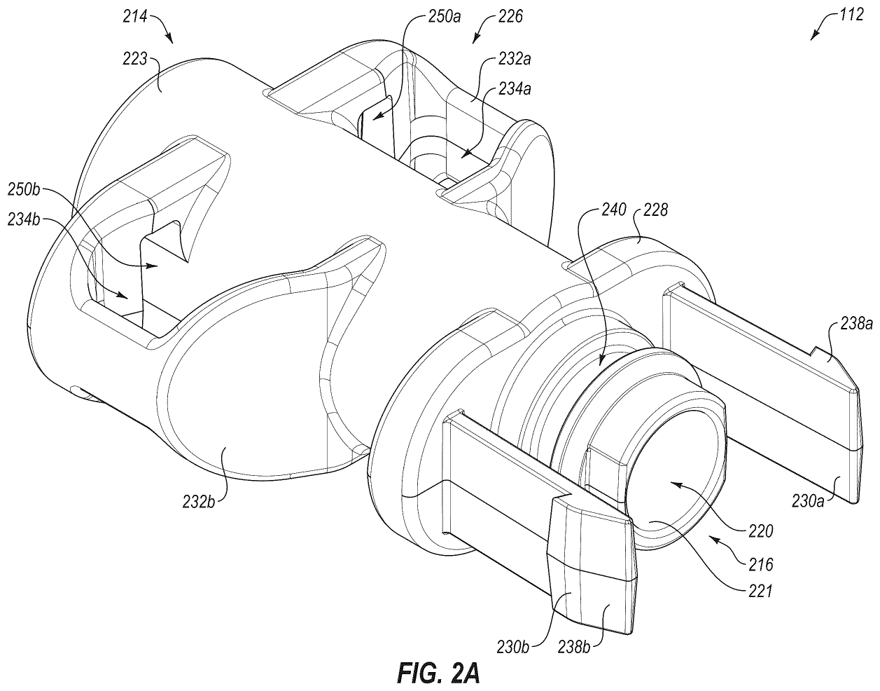

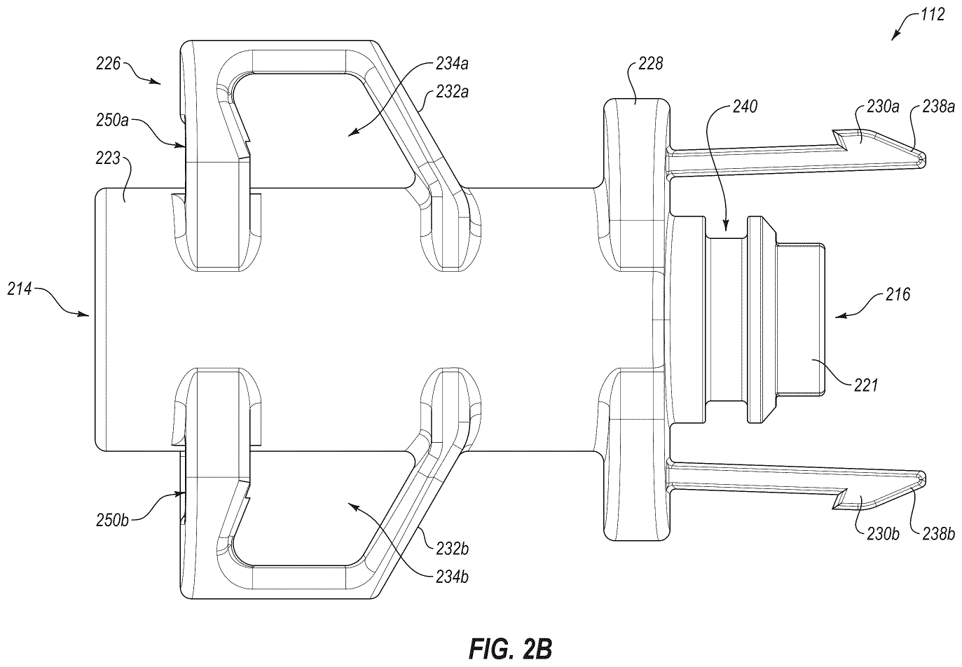

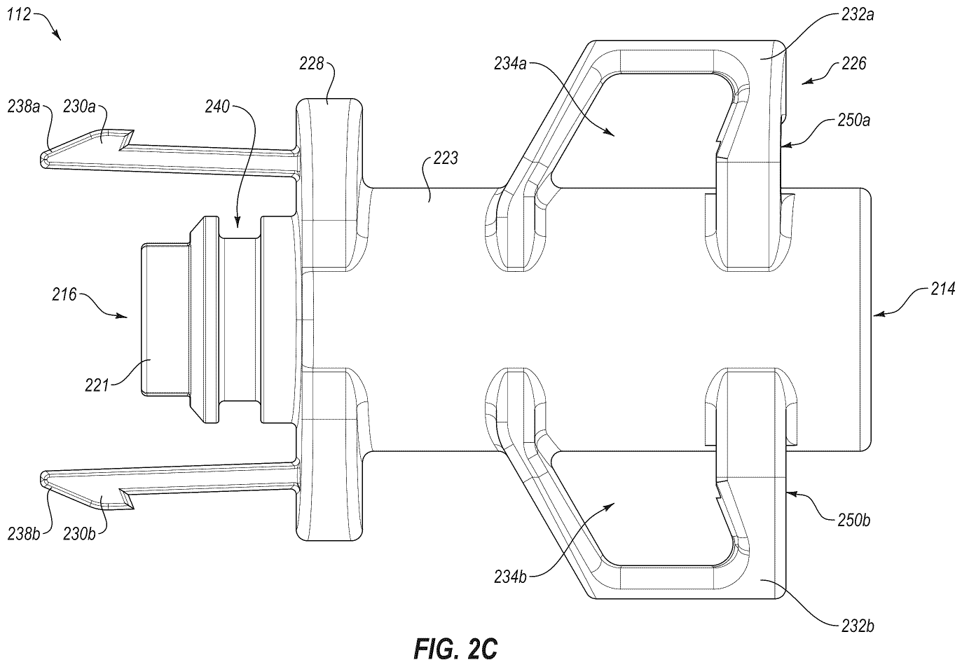

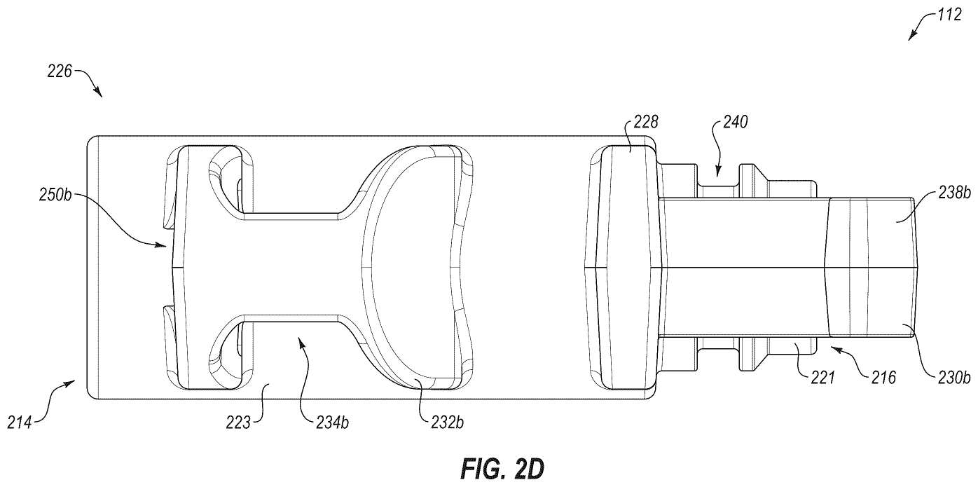

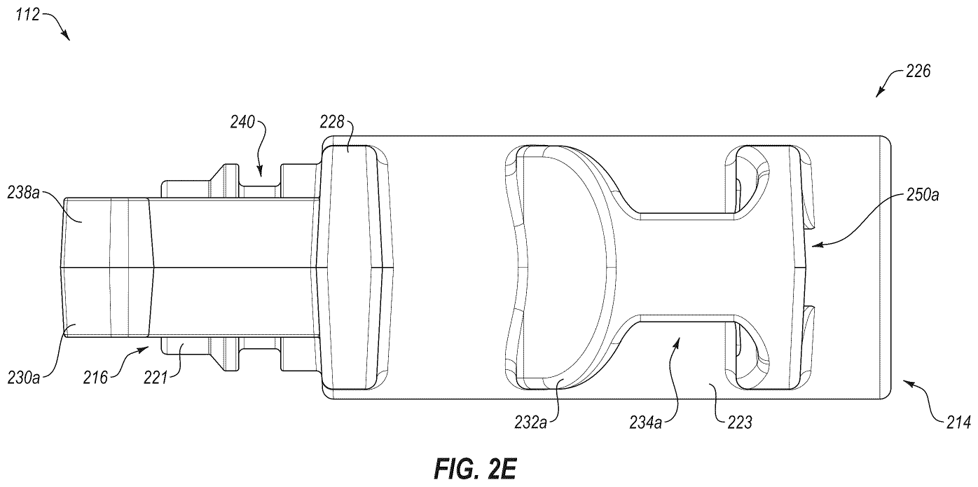

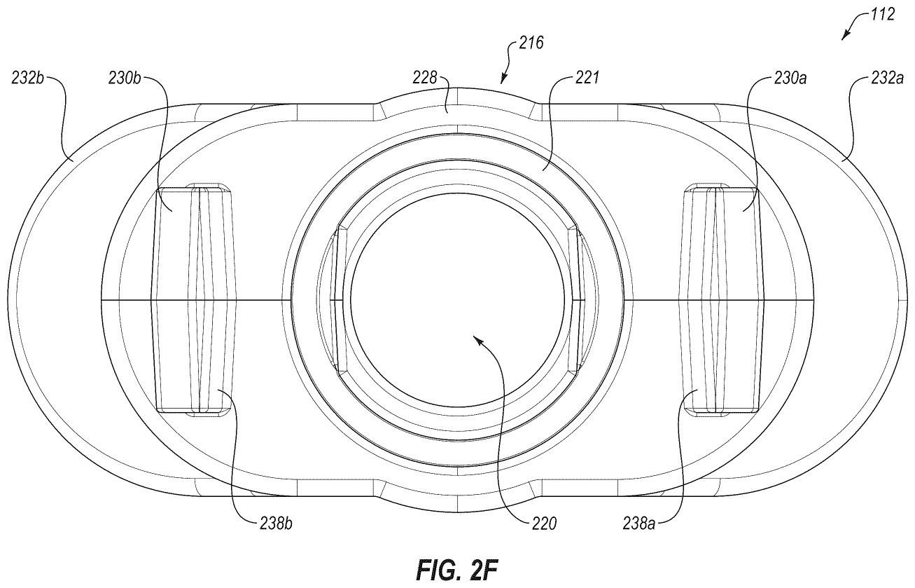

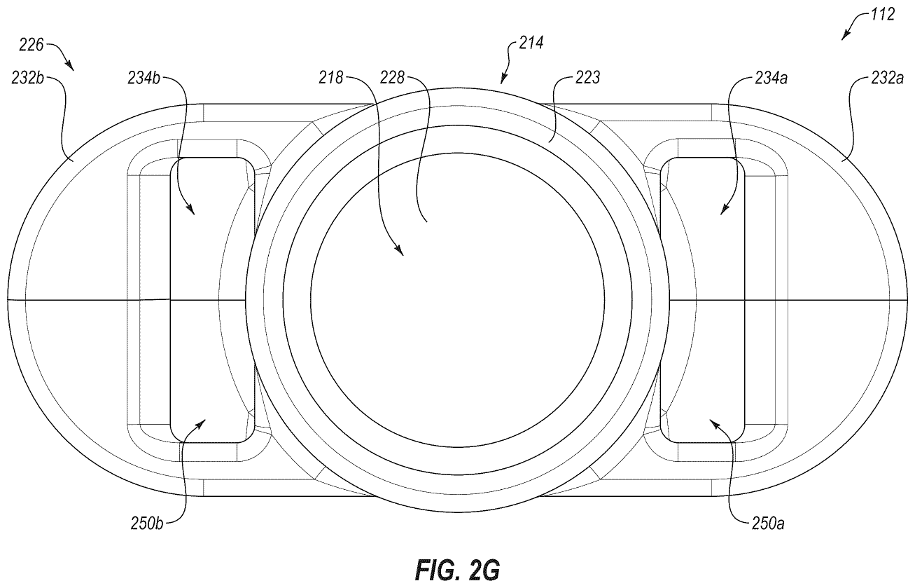

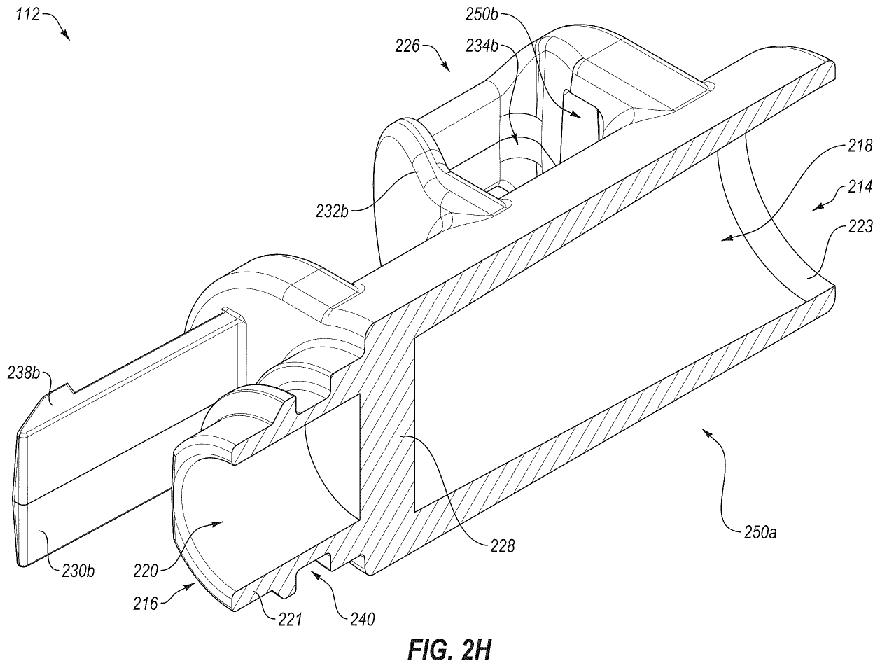

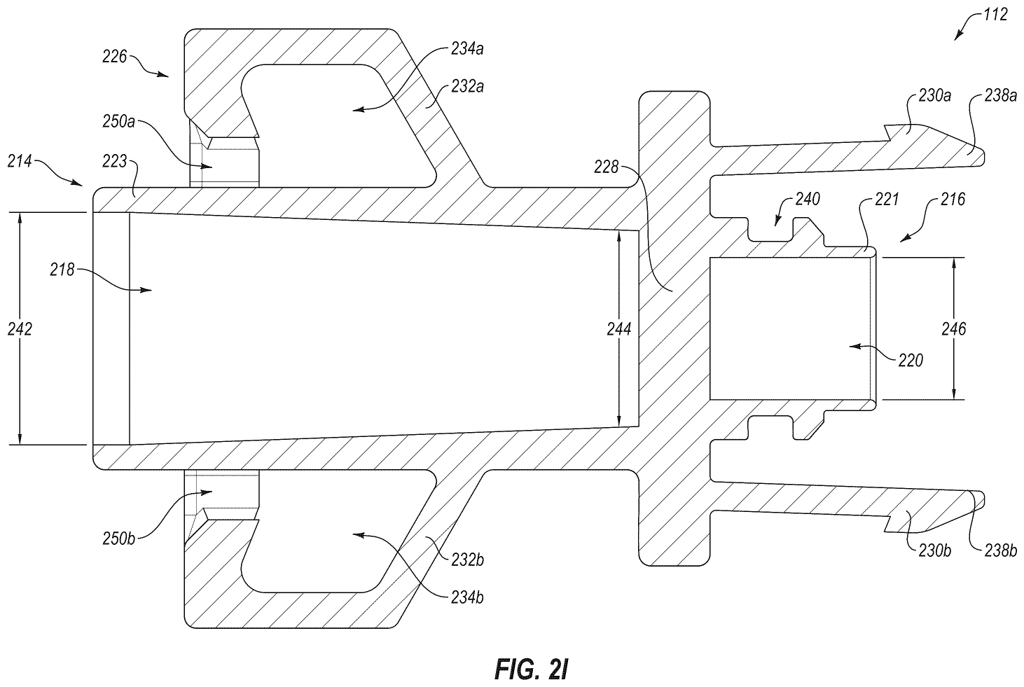

The connector caps 112a-c may be configured to interlock with both the plug ends 102a-b, 113a-b and the socket ends 104a-b, 111a-b to create opens and/or prevent contamination of corresponding conductors. In addition, the connector caps 112a-c may be configured to interlock with both the plug ends 102a-b, 113a-b and the socket ends 104a-b, 111a-b to reduce a number of types of caps that are used within the solar installations 100a-b. The connector caps 112a-c may include features to interlock with the plug ends 102a-b, 113a-b and the socket ends 104a-b, 111a-b to prevent the connector caps 112a-b from unintentionally disconnected. Example features are described in more detail below in relation to FIGS. 2A-4. In addition, the connector caps 112a-c may operate as lockout devices to electrically isolate and/or disable components of the solar installations 100a-b.

Although illustrated and described in relation to the solar installations 100a-b, it is appreciated that the embodiments described in the present disclosure may be implemented in any suitable system environment, such as a power installation, an electric vehicle charging system, or any other appropriate system environment.

With combined reference to FIGS. 1A and 1B and FIGS. 2A-2I, the connector cap 112 may include a socket portion 214 (shown in FIGS. 2A-2E and 2G-2I), a wall 228, and a plug portion 216 (shown in FIGS. 2A-2F, 2H, and 2I). The plug portion 216 may be interlocked with the socket portion 214 via the wall 228.

The socket portion 214, the wall 228, and the plug portion 216 may be sized and shaped so as to electrically isolate the plug ends 102a-b 111a-b, the socket ends 104a-b 113a-b, and/or any other appropriate component of the solar installation 100b. In particular, the connector cap 112 may electrically isolate the conductors of the plug ends 102a-b, 111a-b within a first recess 218 (shown in FIGS. 2G-2I) defined by the socket portion 214 and/or the wall 228. In addition, the connector cap 112 may electrically isolate the conductors of the socket ends 104a-b, 113a-b within a contiguous volume (such as denoted 467 in FIG. 4) defined by a second recess 220 (shown in FIGS. 2A, 2F, 2H, and 2I) and the inner volume of the socket ends 104a-b. The plug portion 216 and/or the wall 228 may define the second recess 220. The first recess 218 and/or the second recess 220 may alternatively be referred to as blind holes.

In some embodiments, the first recess 218 may be defined so as to extend a length of the socket portion 214. In other embodiments, the socket portion 214 may define the first recess 218 so as to only extend a portion of the length of the socket portion 214. In some embodiments, a diameter of the first recess 218 may change along a length of the first recess 218. In these and other embodiments, the diameter of the first recess 218 may decrease as the first recess 218 extends towards the wall 228. For example, as shown in FIG. 21, the first recess 218 may include a greater diameter 242 on an end opposite the wall 228 compared to a diameter 244 proximate the wall 228 (or at least nearer to the wall 228). Alternatively, the diameter of the first recess 218 may increase or be uniform as the first recess 218 extends towards the wall 228. A depth of the first recess 218 may be sized such that at least a portion of the conductors of the plug ends 102a-b 113a-b is positioned within the first recess 218 when interlocked with the connector cap 112.

In some embodiments, the second recess 220 may be defined so as to extend a length of the plug portion 216. In other embodiments, the plug portion 216 may define the second recess 220 so as to only extend a portion of the length of the plug portion 216. In some embodiments, the second recess 220 may include a uniform diameter 246 along a length of the second recess 220. Alternatively, the diameter of the second recess 220 may change along the length of the second recess 220. For example, the diameter of the second recess 220 may increase or decrease along the length of the second recess 220.

The plug portion 216 may be configured to mate with the socket ends 104a-b, 111a-b. In addition, the plug portion 216 may correspond to the positive feed or a positive connection to a voltage source. In some embodiments, the plug portion 216 may define a ring recess 240 (shown in FIGS. 2A-2E, 2H, and 2I) configured to receive an O-ring (not illustrated in FIGS. 2A-2I). A depth of the ring recess 240 and a diameter of the O-ring may be sized such that the O-ring contacts an inner surface of the socket ends 104a-b, 111a-b. The O-ring may contact the inner surfaces to prevent the environmental elements from accessing the inner volumes of the socket ends 104a-b, 111a-b. An example of the connector cap 112 including an O-ring positioned in the ring recess 240 is shown in FIG. 3.

The plug portion 216 may include a protrusion 221 and prongs 230a-b (shown in FIGS. 2A-2F, 2H, and 2I). The prongs 230a-b may be configured to interlock with the socket ends 104a-b, 111a-b. The protrusion 221 and the prongs 230a-b may be connected to and extend from the wall 228. In some embodiments, the prongs 230a-b may extend from the wall in a same direction or generally same direction (e.g., within plus/minus 15 degrees) as the protrusion 221. In these and other embodiments, a distance between the prongs 230a-b may increase as the prongs 230a-b extend from the wall 228. The prongs 230a-b may include hook portions 238a-b that extend out in a direction away from the protrusion 221. The hook portions 238a-b may be configured to pass through hook openings of the socket ends 104a-b, 111a-b. Interlocking the plug portion 216 with an example socket end is described in more detail below in relation to FIGS. 3 and 4.

The socket portion 214 may be configured to interlock with the plug ends 102a-b, 113a-b. In addition, the socket portion 214 may correspond to the negative feed, a negative connection to a voltage source, and/or a ground connection. The socket portion 214 may include projections 232a-b and the first recess 218. The socket portion 214 may be sized and shaped to receive and to position part of the plug ends 102a-b, 113a-b within the first recess 218.

The projections 232a-b may be connected to a body 223 of the socket portion 214 and may receive prongs of the plug ends 102a-b, 113a-b (or even prongs 230a-b of another connector cap 112). In particular, the projections 232a-b may define hook openings 250a-b (shown in FIGS. 2A-2E and 2G-2I) that are configured to receive the prongs of the plug ends 102a-b, 113a-b. The hook openings 250a-b may be positioned and sized such that, when the plug ends 102a-b, 113a-b are interlocked with the connector cap 112, hook portions of the prongs extend through portions of the projections 232a-b and into openings 234a-b (shown in FIGS. 2A-2E and 2G-2I) defined by the projections 232a-b and the body 223.

The hook portions of the prongs of the plug ends 102a-b, 113a-b (which hook portions and prongs may be similar or identical to the hook portions 230a-b and the prongs 238a-b of the connector cap 112) may interlock with the projections 232a-b to prevent the prongs of the plug ends 102a-b, 113a-b from backing out and unintentionally disconnecting from the connector cap 112. For example, the projections 232a-b may be sized and shaped to prevent fingers from accessing the prongs of the plug ends 102a-b, 113a-b within the openings 234a-b and unintentionally disconnecting the plug ends 102a-b. 113a-b from the connector cap 112. However, the openings 234a-b may be sized and/or shaped to permit a disconnect tool to access the prongs of the plug ends 102a-b, 113a-b to force the hook portions of the prongs of the plug ends 102a-b, 113a-b inward (e.g., towards each other). The prongs may flex when a suitable inward-directed force is applied to the hook portions (e.g., through the disconnect tool) to permit the hook portions to move inward. With sufficient inward movement, the hook portions align to the hook openings 250a-b to permit the hook portions to pass back through the hook openings 250a-b. Interlocking the socket portion 214 of the connector cap 112 with an example plug end is described in more detail below in relation to FIGS. 3 and 4.

In some embodiments, the socket portion 214, the plug portion 216, and the wall 228 may include a single unitary piece of material. In these and other embodiments, the single unitary piece of material may include a plastic material, a rubber material, any other appropriate non-conductive material.

With reference to FIG. 3, a separated view of an example junction that includes the connector cap 112 including an O-ring 356, an example plug end 352, and an example socket end 354 is shown. The connector cap 112 may interlock with the plug end 352 and the socket end 354 to protect conductors of the plug end 352 and/or the socket end 354 from the environmental elements and/or to electrically isolate the conductors. The plug end 352 may correspond to the plug ends 102a-b, 113a-b of FIGS. 1A and/or 1B. The socket end 354 may correspond to the socket ends 104a-b, 111a-b of FIGS. 1A and/or 1B.

The plug end 352 may include prongs 360a-b that include hook portions 362a-b that are configured to interlock with the hook openings 250a-b and the projections 232a-b of the connector cap 112. To interlock the plug end 352 with the connector cap 112, the hook portions 362a-b of the plug end 352 may pass through the hook openings 250a-b. In addition, ramped outer surfaces of the hook portions 362a-b of the plug end 352 may contact inward-facing surfaces of the projections 232a-b that define the hook openings 250a-b when entering the hook openings 250a-b. As the hook portions 362a-b are pushed into and partially through the hook openings 250a-b, the inward-facing surfaces of the projections 232a-b urge against the ramped outer surfaces of the hook portions 362a-b, forcing the hook portions 362a-b inward (i.e., toward each other). The prongs 360a-b of the plug end 352 flex inward to accommodate the inward movement of the hook portions 362a-b. When the hook portions 362a-b of the plug end 352 exit the hook openings 250a-b, thereby clearing the inward-facing surfaces of the projections 232a-b, the prongs 360a-b of the plug end 352 may expand outward. Rearward facing surfaces of the hook portions 362a-b of the plug end 352 (e.g., surfaces that face away from the connector cap 112) may contact rearward-facing surfaces of the projections 232a-b (e.g., surfaces that face away from the plug end 352) to interlock the connector cap 112 with the plug end 352 to prevent the plug end 352 from unintentionally disconnecting from the connector cap 112.

The plug end 352 may include a plug portion 358 that defines an inner volume 359. The plug portion 358 may include a protrusion 370 configured to be positioned within the first recess 218 (not illustrated in FIG. 3) to electrically isolate the conductor of the plug end 352. The plug end 352 being interlocked with the connector cap is described in more detail below in relation to FIG. 4.

To disconnect the plug end 352 from the connector cap 112, inward-directed forces may be applied to the hook portions 362a-b of the plug end 352 to force them inward until the rearward-facing surfaces of the hook portions 362a-b clear the rearward-facing surfaces of the projections 232a-b. Flexure of the prongs 360a-b may accommodate the inward movement of the hook portions 362a-b. With the hook portions 362a-b forced inward sufficiently to clear the projections 232a-b (by virtue of the alignment of the hook portions 362a-b to the hook openings 250a-b), the plug end 352 and the connector cap 112 may then be forced axially apart during which the hook portions 362a-b pass backward through the hook openings 250a-b to disconnect the plug end 352 from the connector cap 112. For example, portions of a disconnect tool (not illustrated in FIG. 3) may be positioned within the openings 234a-b to apply the inward forces on the hook portions 362a-b of the plug end 352. The inward forces may prevent the rearward-facing surfaces of the hook portions 362a-b of the plug end 352 from contacting the rearward-facing surfaces of the projections 232a-b and permit the hook portions 362a-b of the plug end 352 to pass back through the hook openings 250a-b.

The socket end 354 may define a plug opening (not illustrated in FIG. 3), hook openings 366a-b, and openings 364a-b that are configured to interlock with the plug portion 216 of the connector cap 112. To interlock the socket end 354 with the connector cap 112, the hook portions 238a-b may pass through the hook openings 366a-b of the socket end 354. In addition, ramped outer surfaces of the hook portions 238a-b may contact inward-facing surfaces of the socket end 354 that define the hook openings 366a-b when entering the hook openings 366a-b, which may force the prongs 230a-b inward as the connector cap 112 is interlocked with the socket end 354. When the hook portions 238a-b exit the hook openings 366a-b of the socket end 354, the prongs 230a-b may expand and rearward-facing surfaces of the hook portions 238a-b (e.g., surfaces that face away from the socket end 354) may contact rearward-facing surfaces of the socket end 354 (e.g., surfaces that face away from the connector cap 112) to interlock the plug portion 216 with the socket end 354 to prevent the connector cap 112 from unintentionally disconnecting from the socket end 354. In addition, when the hook portions 238a-b exit the hook openings 366a-b of the socket end 354, the hook portions 238a-b may be positioned within the openings 364a-b defined by the socket end 354.

To disconnect the socket end 354 from the connector cap 112, inward-directed forces may be applied to the hook portions 238a-b via the openings 364a-b of the socket end 354 to force the hook portions 238a-b inward until the rearward-facing surfaces of the hook portions 238a-b clear the rearward-facing surfaces of the socket end 354. Flexure of the prongs 230a-b may accommodate the inward movement of the hook portions 238a-b. With the hook portions 238a-b forced inward sufficiently to clear the rearward-facing surfaces of the socket end 354 (by virtue of the alignment of the hook portions 238a-b to the hook openings 366a-b), the connector cap 112 and the socket end 354 may then be forced axially apart during which the hook portions 238a-b pass backward through the hook openings 366a-b to disconnect the connector cap 112 from the socket end 354. For example, portions of the disconnect tool may be positioned within the openings 364a-b defined by the socket end 354 to apply the inward forces to the hook portions 238a-b. The inward forces may prevent the rearward-facing surfaces of the hook portions 238a-b from contacting the rearward-facing surfaces of the socket end 354 and permit the hook portions 238a-b to pass back through the hook openings 366a-b defined by the socket end 354.

With reference to FIG. 4, a top cross-sectional view of an example junction that include the connector cap 112 interlocked with the example plug end 352 and the example socket end 354 is shown. The O-ring 356 is omitted in FIG. 4.

While the plug end 352 is interlocked with the connector cap 112, the hook portions 362a-b of the plug end 352 may interlock with the projections 232a-b of the connector cap 112. In addition, at least a portion of the plug portion 358 of the plug end 352 may be positioned within the first recess 218. The plug portion 358 of the plug end 352 may house or otherwise include a conductor 470 that is at least partially positioned within the first recess 218 while the plug end 352 is interlocked with the connector cap 112. The conductor 470 of the plug end 352 may be electrically isolated within the first recess 218, the inner volume 359 of the plug portion 358, or both. In addition, the connector cap 112 may prevent dirt and other contaminants from getting into the inner volume 359 defined by the plug end 352 of FIGS. 3 and 4.

The socket end 354 may define a plug opening 474. The plug opening 474, the hook openings 366a-b, and/or the openings 364a-b may be configured to interlock with the plug portion 216 of the connector cap 112. While the socket end 354 is interlocked with the connector cap 112, at least a portion of the plug portion 216 may be positioned within the plug opening 474. The plug portion 216 may be positioned within the plug opening 474 such that the second recess 220 and an inner volume 468 of the socket end 354 form a contiguous volume 467. The socket end 354 may include a conductor 472 that, when the socket end 354 is interlocked with the connector cap 112, is electrically isolated within the contiguous volume 467. In addition, the connector cap 112 may prevent the environmental elements from getting into the second recess 220, the plug opening 474, and/or the inner volume 468.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used in the present disclosure to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A connector cap comprising:
a socket portion at least partially defining a first recess, the socket portion configured to interlock with a plug end of a first device to position at least part of the plug end of the first device within the first recess;
a plug portion configured to mate with a socket end of a second device to interlock the plug portion and the socket end of the second device and to position at least part of the plug portion within an inner volume of the socket end of the second device; and
a wall connected to the socket portion and the plug portion, the wall further defining the first recess, wherein the wall, the socket portion, and the plug portion are configured to electrically isolate the plug end of the first device from the socket end of the second device when the first device and the second device are interlocked with the connector cap.

2. The connector cap of claim 1 further comprising a plurality of projections sized and positioned so as to interlock the plug end of the first device and the socket portion to prevent the plug end of the first device from unintentionally disconnecting from the connector cap.

3. The connector cap of claim 2, wherein the plurality of projections define a plurality of hook openings configured to receive hook portions of the plug end of the first device.

4. The connector cap of claim 1, wherein a diameter of the first recess decreases as the first recess extends towards the wall.

5. The connector cap of claim 1, wherein the plug portion defines a second recess comprising a uniform diameter along a length of the second recess.

6. The connector cap of claim 5, wherein the second recess is sized and positioned to connect to the inner volume of the socket end of the second device to form a contiguous volume.

7. The connector cap of claim 1, wherein the plug portion defines a ring recess configured to receive an O-ring such that the O-ring contacts an inner surface of the socket end of the second device to prevent exposure of the inner volume of the socket end of the second device to dirt or other environmental elements.

8. The connector cap of claim 1, wherein the plug portion comprises a protrusion and a plurality of prongs extending from the wall, the plurality of prongs configured to interlock with the socket end of the second device.

9. The connector cap of claim 1, wherein the socket portion, the plug portion, and the wall comprise a single unitary piece of material.

10. The connector cap of claim 1, wherein the connector cap is compatible with Multi-Contact (MC) 4 connectors.

11. A system comprising:
a first device comprising a plug end;
a second device comprising a socket end; and
a connector cap comprising:
a socket portion at least partially defining a first recess, the socket portion configured to interlock with a plug end of a first device to position at least part of the plug end of the first device within the first recess;
a plug portion configured to mate with a socket end of a second device to interlock the plug portion and the socket end of the second device and to position at least part of the plug portion within an inner volume of the socket end of the second device; and
a wall connected to the socket portion and the plug portion, the wall further defining the first recess, wherein the wall, the socket portion, and the plug portion are configured to electrically isolate the plug end of the first device from the socket end of the second device when the first device and the second device are interlocked with the connector cap.

12. The system of claim 11 further comprising a plurality of projections sized and positioned so as to interlock the plug end of the first device and the socket portion to prevent the plug end of the first device from unintentionally disconnecting from the connector cap.

13. The system of claim 12, wherein the plurality of projections define a plurality of hook openings configured to receive hook portions of the plug end of the first device.

14. The system of claim 11, wherein the plug portion defines a second recess comprising a uniform diameter along a length of the second recess.

15. The system of claim 14, wherein the second recess is sized and positioned to connect to the inner volume of the second device to form a contiguous volume.

16. The system of claim 11, wherein the plug portion defines a ring recess configured to receive an O-ring such that the O-ring contacts an inner surface of the socket end of the second device to prevent exposure of the inner volume of the socket end of the second device to dirt or other environmental elements.

17. The system of claim 11, wherein the plug portion comprises a protrusion and a plurality of prongs extending from the wall, the plurality of prongs configured to interlock with the socket end of the second device.

18. The system of claim 11, wherein the socket portion, the plug portion, and the wall comprise a single unitary piece of material.

19. The system of claim 11, wherein a depth of the first recess is sized such that a conductor of the plug end of the first device is at least partially positioned within the first recess when the first device is interlocked with the connector cap.

20. The system of claim 11, wherein the connector cap is compatible with Multi-Contact (MC) 4 connectors.
